(19) United States
(12) Patent Application Publication
(10) Pub. No.: US 2024/0279382 A1
(43) Pub. Date: Aug. 22, 2024

(54) POLYAMINES AS ALDEHYDE SCAVENGERS

(71) Applicant: BASF SE, Ludwigshafen am Rhein (DE)

(72) Inventors: Zeljko TOMOVIC, Eindhoven (NL); Maximilian ` JOOST, Lemfoerde (DE); Alexander Michael Haydl, Mannheim (DE); Eugen RISTO, Ludwigshafen am Rhein (DE)

(21) Appl. No.: 18/563,507

(22) PCT Filed: Jun. 7, 2022
(86) PCT No.: PCT/EP22/65391

§ 371 Date: Nov. 22, 2023

(30) Foreign Application Priority Data
Jun. 14, 2021 (EP) 21179329.4

(51) Int. Cl. C08G 18/48; C08G 18/12; C08G 18/18; C08G 18/30; C08G 18/40; C08G 18/42; C08G 73/02; C08L 79/02

(52) U.S. Cl. CPC C08G 18/485; C08G 18/12; C08G 18/18; C08G 18/302; C08G 18/4018; C08G 18/4216; C08G 73/0206; C08L 79/02; C08G 2110/0066; C08G 2110/0083

(57) ABSTRACT

Disclosed herein are processes for producing polyurethanes including mixing (a) polyisocyanate, (b) polymeric compounds having isocyanate-reactive groups, (c) optionally catalysts, (d) polymeric amines of general formula H₂N—W-NR-[W-NR]ₗ-[Q-NR]ₘ-[S—NR]ₙ-W-NH₂ and optionally (e) blowing agents, (f) chain extenders and/or crosslinking agents and (g) auxiliaries and/or additives to form a reaction mixture and reacting the reaction mixture to afford the polyurethane where the polydispersity of the polymeric amines (d) is at least 1.2. Further disclosed herein are a polyurethane produced by the process, a method of using such a polyurethane in enclosed spaces and a composition including (b) polymeric compounds having isocyanate-reactive groups, (c) catalysts and (d) polymeric amines of general formula H₂N—W-NR-[W-NR]ₗ-[Q-NR]ₘ-[S—NR]ₙ-W-NH₂ and blowing agents including water, where the polydispersity of the polymeric amines (d) is at least 1.2.

The present invention relates to processes for producing polyurethanes comprising mixing (a) polyisocyanate, (b) polymeric compounds having isocyanate-reactive groups, (c) optionally catalysts, (d) polymeric amines of general formula H₂N—W-NR-[W-NR]ₗ-[Q-NR]ₘ-[S—NR]ₙ-W-NH₂ and optionally (e) blowing agents, (f) chain extenders and/or crosslinking agents and (g) auxiliaries and/or additives to form a reaction mixture and reacting the reaction mixture to afford the polyurethane, wherein each W independently at each occurrence represents a linear or branched-chain hydrocarbon having 3 to 10 carbon atoms, each Q represents an ethylene radical, each S independently at each occurrence represents a substituted hydrocarbon, each R independently at each occurrence represents hydrogen or a hydrocarbon radical having 1 to 10 carbon atoms, H represents a hydrogen atom and N represents a nitrogen atom, I represents values from 0 to 100, m represents values from 0 to 50 and n represents values from 0 to 100, wherein the polydispersity of the polymeric amines (d) is at least 1.2. The present invention further relates to a polyurethane producible by a process according to the invention and to the use of such a polyurethane in enclosed spaces, for example in means of transport, and to a composition comprising (b) polymeric compounds having isocyanate-reactive groups, (c) catalysts and (d) polymeric amines of general formula H₂N—W-NR-[W-NR]ₗ-[Q-NR]ₘ-[S—NR]ₙ-W-NH₂ and blowing agents comprising water, wherein the polydispersity of the polymeric amines (d) is at least 1.2.

Polyurethanes have numerous applications, for example in the furniture industry as seat cushioning or as a binder for particle board, as an insulation material in the construction industry, as an insulation material, for example of pipes, hot water storage tanks or refrigerators, and as trim pieces, for example in automotive manufacture. Polyurethanes are often employed in particular in automobile manufacturing, for example in automobile exterior trim as spoilers, roof elements, suspension elements and in automobile interior trim as headliners, foam carpet backings, door trims, steering wheels, gear knobs and seat cushioning.

It is known that polyurethanes have a propensity for emitting organic substances which can cause unpleasant odors or, in the case of high concentrations, unwellness. Enclosed spaces, for example in the interior of buildings or vehicles, for example automobiles, in particular are particularly affected. One example of such emissions is the emission of aldehydes. Different approaches for reducing aldehyde emissions are already in existence.

Thus for example EP 1428847 describes that aldehyde emissions may be reduced by subsequent addition of polymeric substances having primary and/or secondary amino groups. The amine groups in the polymer are responsible for the reduction in emissions. Polyvinylamine, polyethyleneimine and polyamidoamines are specifically mentioned. A disadvantage of using polyvinylamine is, for example, that this substance may comprise impurities, that lead to corrosion of containers and equipment, as a consequence of the production process. While polyethyleneimine acts as a formaldehyde scavenger it leads to increased acetaldehyde emissions.

US 20130203880 describes the use of polyhydrazodicarbonamide as a substance for reducing aldehyde emissions in polyurethane foams. However, a marked reduction in aldehydes is only achieved upon addition of a large amount of polyhydrazodicarbonamide of 2% to 5.5% by weight in the polyol component. Since polyhydrazodicarbonamide likewise has catalytic properties the addition of this substance on this scale alters the reaction profile. Furthermore, the aldehyde reduction achieved is in further need of improvement even when large amounts of polyhydrazodicarbonamide are employed.

WO 2015082316 describes the use of CH-acidic compounds of general formula R¹—CH₂—R², wherein R¹ and R² independently of one another represent an electron withdrawing radical for reducing formaldehyde emissions in combination with incorporable catalysts. This can efficiently reduce formaldehyde but the foam specimens still exhibit high emissions of volatile organic substances (VOC).

EP 3310824 describes a process for producing polyurethanes wherein polyisocyanates and polyols are reacted in the presence of an aldehyde scavenger selected from 1-benzyl-1,3-propane-diamine, isotridecyloxypropyl-1,3-diaminopropane, dodecyloxypropyl-1,3-diaminopropane and hexyloxypropyl-1,3-diaminopropane. The aldehyde scavengers described in EP 3310824 have the disadvantage that these lower molecular weight amines usually tend to exhibit higher toxicities.

It is accordingly an object of the present invention to provide polyurethanes, in particular polyurethane foams, which have improved emission characteristics, in particular of aldehydes, such as formaldehyde, and which also exhibit exceptional emission characteristics of further compounds, such as nitrogen-containing emissions and odor emissions.

The object of the invention is achieved by a polyurethane producible by a process comprising mixing (a) polyisocyanate, (b) polymeric compounds having isocyanate-reactive groups, (c) optionally catalysts, (d) polymeric amines of general formula H₂N—W-NR-[W-NR]ₗ-[Q-NR]ₘ-[S—NR]ₙ-W-NH₂ and optionally (e) blowing agents, (f) chain extenders and/or crosslinking agents and (g) auxiliaries and/or additives to form a reaction mixture and reacting the reaction mixture to afford the polyurethane, wherein each W independently at each occurrence represents a linear or branched-chain hydrocarbon having 3 to 10 carbon atoms, each Q represents an ethylene radical, each S independently at each occurrence represents a substituted hydrocarbon, each R independently at each occurrence represents hydrogen or a hydrocarbon radical having 1 to 10 carbon atoms, H represents a hydrogen atom and N represents a nitrogen atom, I represents values from 0 to 100, m represents values from 0 to 50 and n represents values from 0 to 100, wherein the polydispersity of the polymeric amines (d) is at least 1.2. The present invention further relates to a polyurethane producible by a process according to the invention and to the use of such a polyurethane in enclosed spaces, for example in means of transport, and to a composition comprising (b) polymeric compounds having isocyanate-reactive groups, (c) catalysts and (d) polymeric amines of general formula H₂N—W-NR-[W-NR]ₗ-[Q-NR]ₘ-[S—NR]ₙ-W-NH₂ and blowing agents comprising water, wherein the polydispersity of the polymeric amines (d) is at least 1.2.

For the purposes of the invention, the term “polyurethane” encompasses all known polyisocyanate polyaddition products. These encompass addition products derived from isocyanate and alcohol, and also encompass modified polyurethanes, which can comprise isocyanurate structures, allophanate structures, urea structures, carbodiimide structures, uretonimine structures, biuret structures, and other isocyanate addition products. These polyurethanes according to the invention comprise in particular solid polyisocyanate polyaddition products, such as duromers, and foams based on polyisocyanate-polyaddition products, such as flexible foams, semi-rigid foams, rigid foams or integral foams and also polyurethane coatings and binders. The polyurethanes according to the invention are preferably polyurethane foams or solid polyurethanes which comprise no further polymers in addition to the polyurethane units (a) to (g) elucidated hereinbelow.

In the context of the invention “polyurethane foams” are to be understood as meaning foams according to DIN 7726. Flexible polyurethane foams according to the invention have a compressive stress at 10% compression/compressive strength according to DIN 53 421/DIN EN ISO 604 of 15 kPa or less, preferably 1 to 14 kPa and in particular 4 to 14 kPa. Semi-rigid polyurethane foams according to the invention have a compressive stress at 10% compression according to DIN 53 421/DIN EN ISO 604 of more than 15 to less than 80 kPa. According to DIN ISO 4590 semi-rigid polyurethane foams and flexible polyurethane foams according to the invention have an open-cell content of preferably more than 85%, particularly preferably more than 90%. Further details about flexible polyurethane foams and semi-rigid polyurethane foams according to the invention may be found in “Kunststoffhandbuch”, volume 7, “Polyurethane”, Carl Hanser Verlag, 3rd edition 1993, chapter 5.

The rigid polyurethane foams according to the invention exhibit a compressive stress at 10% compression of not less than 80 kPa, preferably not less than 120 kPa, particularly preferably not less than 150 kPa. Furthermore, the rigid polyurethane foam has a closed-cell content of more than 80%, preferably more than 90%, according to DIN ISO 4590. Further details about rigid polyurethane foams according to the invention may be found in “Kunststoffhandbuch”, volume 7, “Polyurethane”, Carl Hanser Verlag, 3rd edition 1993, chapter 6.

In the context of the present invention “elastomeric polyurethane foams” is to be understood as meaning polyurethane foams according to DIN 7726 which after brief deformation by 50% of their thickness according to DIN 53 577 show no lasting deformation above 2% of their starting thickness after 10 minutes. A rigid polyurethane foam, a semi-rigid polyurethane foam or a flexible polyurethane foam may be concerned.

Integral polyurethane foams are polyurethane foams according to DIN 7726 having a boundary zone which have a higher density than the core as a consequence of the shaping process. The overall apparent density averaged over the core and the edge zone is preferably more than 100 g/L. In the context of the present invention integral polyurethane foams may also be rigid polyurethane foams, semi-rigid polyurethane foams or flexible polyurethane foams. Further details about integral polyurethane foams according to the invention may be found in “Kunststoffhandbuch”, volume 7, “Polyurethane”, Carl Hanser Verlag, 3rd edition 1993, chapter 7.

In a preferred embodiment the polyurethane according to the invention is a polyurethane foam having an average density of 10 to 850 g/L, preferably a semi-rigid polyurethane foam or a flexible polyurethane foam or a rigid polyurethane foam, particularly preferably an elastomeric flexible polyurethane foam, a semi-rigid polyurethane foam or an elastomeric integral polyurethane foam. The elastomeric integral polyurethane foam preferably has a density averaged over the core and the edge zone of 150 g/L to 500 g/L. The flexible polyurethane foam preferably has an average density of 10 to 100 g/L. The semi-rigid polyurethane foam preferably has an average density of 70 to 150 g/L.

In a further preferred embodiment the polyurethane is a solid polyurethane having a density of preferably more than 850 g/L, preferably 900 to 1400 g/L and particularly preferably 1000 to 1300 g/L. This affords a solid polyurethane without addition of a blowing agent. In the context of the present invention small amounts of blowing agent, for example water, present in the polyols as a consequence of production are not to be interpreted as constituting addition of blowing agent. The reaction mixture for production of the compact polyurethane preferably comprises less than 0.2% by weight, particularly preferably less than 0.1% by weight and in particular less than 0.05% by weight, of water.

The polyurethane according to the invention is preferably employed in the interior of means of 5 transport, such as ships, airplanes, lorries, passenger cars or buses, especially preferably passenger cars or buses and especially passenger cars. The interior of passenger cars and buses is hereinbelow referred to as an automotive interior part. A flexible polyurethane foam can be used as a seat cushion, a semi-rigid polyurethane foam as back-foaming for door trim elements or instrument panels, an integral polyurethane foam as a steering wheel, gear knob or headrest and a solid polyurethane as a cable sheathing for example.

The polyisocyanate components (a) used for producing the polyurethanes according to the invention comprise all polyisocyanates known for the production of polyurethanes. These comprise the aliphatic, cycloaliphatic and aromatic divalent or polyvalent isocyanates known from the prior art and any desired mixtures thereof. Examples are diphenylmethane 2,2′-, 2,4′- and 4,4′-diisocyanate, the mixtures of monomeric diphenylmethane diisocyanates with diphenylmethane diisocyanate homologs having a larger number of rings (polymer MDI), isophorone diisocyanate (IPDI) and its oligomers, tolylene 2,4- or 2,6-diisocyanate (TDI) and mixtures of these, tetramethylene diisocyanate and its oligomers, hexamethylene diisocyanate (HDI) and its oligomers, naphthylene diisocyanate (NDI) and mixtures thereof.

Preference is given to using 2,4- and/or 2,6-tolylene diisocyanate (TDI) or mixtures thereof, monomeric diphenylmethane diisocyanates and/or higher nuclear homologs of diphenylmethane diisocyanate (polymer MDI) and mixtures thereof. Further possible isocyanates are recited for example in “Kunststoffhandbuch”, volume 7, “Polyurethane”, Carl Hanser Verlag, 3rd edition 1993, chapters 3.2 and 3.3.2.

The polyisocyanate component (a) may be employed in the form of polyisocyanate prepolymers. These polyisocyanate prepolymers are obtainable by reacting an excess of the above-mentioned polyisocyanates (constituent (a-1)) with polymeric compounds having isocyanate-reactive groups (b) (constituent (a-2)) and/or chain extenders (f) (constituent (a-3)) for example at temperatures of 30° ° C. to 100° C., preferably at about 80° C., to afford the isocyanate prepolymer.

Polymeric compounds having isocyanate-reactive groups (a-2) and chain extenders (a3) are known to those skilled in the art and described for example in “Kunststoffhandbuch [Plastics Handbook], 7, Polyurethane [Polyurethanes]”, Carl Hanser Verlag, 3rd edition 1993, chapter 3.1. Thus also employable as polymeric compounds having isocyanate-reactive groups (a-2) are for example the polymeric compounds having isocyanate-reactive groups described below under (b).

Employable polymeric compounds having isocyanate-reactive groups (b) include all known compounds having at least two isocyanate-reactive hydrogen atoms, for example those having a functionality of 2 to 8 and a number-average molecular weight of 400 to 15 000 g/mol. It is thus possible to use for example compounds selected from the group comprising polyether polyols, polyester polyols and mixtures thereof.

Polyetherols are produced for example from epoxides, such as propylene oxide and/or ethylene oxide, or from tetrahydrofuran with hydrogen-active starter compounds, such as aliphatic alcohols, phenols, amines, carboxylic acids, water and compounds based on natural substances, such as sucrose, sorbitol or mannitol, using a catalyst. These may include basic catalysts or double-metal cyanide catalysts, as described for example in PCT/EP2005/010124, EP 90444 or WO 05/090440.

Polyesterols are by way of example produced from aliphatic or aromatic dicarboxylic acids and polyhydric alcohols, polythioether polyols, polyesteramides, hydroxylated polyacetals and/or hydroxylated aliphatic polycarbonates, preferably in the presence of an esterification catalyst. Further possible polyols are recited, for example, in “Kunststoffhandbuch”, volume 7, “Polyurethane”, Carl Hanser Verlag, 3rd edition, 1993, chapter 3.1.

Also employable in addition to the described polyetherols and polyesterols are filler-containing polyetherols and polyesterols, also known as polymer polyetherols or polymer polyesterols. Such compounds preferably comprise dispersed particles of thermoplastics, for example constructed from olefinic monomers, such as acrylonitrile, styrene, (meth)acrylates, (meth)acrylic acid and/or acrylamide. Such filler-containing polyols are known and commercially available. The production thereof is described, for example, in DE 111 394, U.S. Pat. Nos. 3,304,273, 3,383,351, 3,523,093, DE 1 152 536, DE 1 152 537, WO 2008/055952 and WO2009/128279. It is further possible to employ as the polymeric compounds according to the invention having isocyanate-reactive groups (b) at least one polyesterol obtainable by polycondensation of an acid component with an alcohol component, wherein the acid component is malonic acid and/or derivatives thereof and the alcohol component is an aliphatic dialcohol having 4 to 12 carbon atoms. The production thereof is described for example in WO 2019/149583.

In a particularly preferred embodiment of the present invention the component (b) comprises polyetherols and more preferably no polyesterols.

The catalytic effect of the compounds of general formula H₂N—W-NR-[W-NR]ₗ-[Q-NR]ₘ-[S—NR]ₙ-W-NH₂ (d) makes it possible to reduce the use of further polyurethane catalysts. If further catalysts (c) are employed all customary polyurethane catalysts may be used. If employed, the catalysts (c) preferably comprise incorporable amine catalysts, particularly preferably consist of incorporable amine catalysts.

Typical catalysts employable for production of the polyurethanes include for example amidines, such as 2,3-dimethyl-3,4,5,6-tetrahydropyrimidine, tertiary amines, such as triethylamine, tributylamine, dimethylbenzylamine, N-methyl-, N-ethyl- and N-cyclohexylmorpholine, N,N, N′, N′-tetramethylethylenediamine, N, N,N′, N′-tetramethylbutanediamine, N,N,N′, N′-tetramethylhexanediamine, pentamethyldiethylenetriamine, tetramethyldiaminoethyl ether, bis(dimethylaminopropyl)urea, dimethylpiperazine, 1,2-dimethylimidazole, 1-azabicyclo[3.3.0]octane and preferably 1,4-diazabicyclo[2.2.2]octane and alkanolamine compounds, such as triethanolamine, triisopro-panolamine, N-methyl- and N-ethyldiethanolamine and dimethylethanolamine. Also contem-plated are organometallic compounds, preferably organotin compounds, such as tin(II) salts of organic carboxylic acids, for example tin(II) acetate, tin(II) octoate, tin(II) ethylhexoate and tin(II) laurate, and the dialkyltin(IV) salts of organic carboxylic acids, for example dibutyltin diacetate, dibutyltin dilaurate, dibutyltin maleate and dioctyltin diacetate, and also bismuth carboxylates, such as bismuth(III) neodecanoate, bismuth 2-ethylhexanoate and bismuth octanoate, or mixtures thereof. The organometallic compounds can be used alone or preferably in combination with strongly basic amines. If component (b) is an ester it is preferable to use exclusively amine catalysts.

Incorporable amine catalysts have at least one, preferably 1 to 8 and particularly preferably 1 to 2 isocyanate-reactive groups, such as primary amine groups, secondary amine groups, hydroxyl groups, amides or urea groups, preferably primary amine groups, secondary amine groups, hydroxyl groups. Incorporable amine catalysts are mostly used for the production of low-emission polyurethanes which are especially used in automotive interiors. Such catalysts are known and described for example in EP1888664. These comprise compounds which, in addition to the isocyanate-reactive group(s), preferably comprise one or more tertiary amino groups. It is preferable when at least one of the tertiary amino groups in the incorporable catalysts bears at least two aliphatic hydrocarbon radicals, preferably having 1 to 10 carbon atoms per radical, particularly preferably having 1 to 6 carbon atoms per radical. It is particularly preferable when the tertiary amino groups bear two radicals independently of one another selected from methyl and ethyl and also a further organic radical. Examples of incorporable catalysts that may be used are bis(dimethylaminopropyl)urea, bis(N,N-dimethylaminoethoxyethyl) carbamate, dimethylaminopropylurea, N, N,N-trimethyl-N-hydroxyethylbis(aminopropyl ether), N,N,N-trime-thyl-N-hydroxyethylbis(aminoethyl ether), diethylethanolamine, bis(N,N-dimethyl-3-aminopro-pyl)amine, 1-(3-aminopropyl)pyrrolidine, dimethylaminopropylamine, 3-dimethylaminopropyl-N,N-dimethylpropane-1,3-diamine, dimethyl-2-(2-aminoethoxyethanol), (1,3-bis(dimethyla-mino)propan-2-ol), N,N-bis(3-dimethylaminopropyl)-N-isopropanolamine, bis(dimethylaminopro-pyl)-2-hydroxyethylamine, N,N,N-trimethyl-N-(3-aminopropyl)bis(aminoethyl ether), 1,4-diazabicyclo[2.2.2]octane-2-methanol and 3-dimethylaminoisopropyldiisopropanolamine or mixtures thereof.

When catalysts (c) are employed these may be employed for example in a concentration of 0.001% to 5% by weight, in particular 0.05% to 2% by weight, as a catalyst/catalyst combination based on the total weight of the component (b).

Suitable polymeric amines (d) include compounds of general formula H₂N—W-NR-[W-NR]ₗ-[Q-NR]ₘ-[S—NR]ₙ-W-NH₂, wherein the polydispersity of the polymeric amines (d) is at least 1.2. H represents a hydrogen atom and N represents a nitrogen atom.

Each W independently at each occurrence represents a linear or branched-chain hydrocarbon having 3 to 10 carbon atoms, preferably a propylene or butylene radical and in particular a propylene radical.

Each Q represents an ethylene radical. Each S independently at each occurrence represents a substituted hydrocarbon, for example a halogen-substituted or an oxygen-substituted alkylene radical or a cyclic radical. Examples include CH₂—CH₂—O—CH₂—CH₂— radicals or radicals of formula

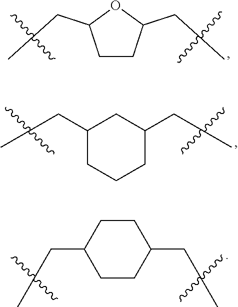

Each R independently at each occurrence represents hydrogen or a hydrocarbon radical having 1 to 10 carbon atoms. It is preferable when each R represents a hydrogen atom, a methyl radical, an ethyl radical or a propyl radical, particularly preferably a methyl radical or hydrogen. It is particularly preferable when at least 50%, particularly preferably at least 75% and in particular 100% of the R radicals represent hydrogen atoms.

The indices I and n represent values from 0 to 100, m from 0 to 50. The indices are chosen such that the number-average molecular weight of a polymeric amine (d) is preferably 300 to 5000 g/mol, particularly preferably 400 to 3000 g/mol and in particular 600 to 1500 g/mol. Since the polymeric amine (d) has a molecular weight distribution, the values for l, m and n are obtained by averaging and can thus assume fractional values. The number-average molecular weight may be determined for example by GPC. In the context of the present invention GPC measurements were performed using a combination of three columns: HFIP-LG Guard, PL HFIPGEL and PL HFIPGel. The eluent was conveyed at a constant flow of 1 ml/min with hex-afluoroisopropanol and 0.05% by weight of potassium trifluoroacetate. The injected sample was pumped through a Millipore Millex FG pre-filter (0.2 μm). 50 μL were injected at a concentration of 1.5 mg/ml (diluted in eluent). The column output was measured using a DRI Agilent 1100 UV detector at λ=230 and 280 nm. Calibration was performed with a PMMA standard (PSS, Mainz, Germany) having a molar mass of 800 to 2 200 000 g/mol. Values outside the calibration range were extrapolated. The polydispersity, calculated from the quotient of the weight-average molecular weight and the number-average molecular weight, is preferably at least 1.2, particularly preferably 1.3 to 10 and in particular 1.5 to 5.

The units —W—NR—, -Q-NR- and —S—NR— may have any desired arrangement in the molecule, for example alternating, blockwise or random, preferably random, provided it is ensured that H₂N-W- is present as a terminal group.

The polymeric amine (d) may be produced by means of a polytransamination. The primary amines which may be used as starting substances for producing the polymeric amines (d) preferably have propyleneamine radicals as end groups. Further primary diamines may be employed in addition to the propyleneamine-comprising diamines. These comprise linear, branched or cyclic aliphatic diamines. Examples of such further diamines are ethylenediamine, butylenediamine (for example 1,4-butylenediamine or 1,2-butylenediamine), diaminopentane (for example 1,5-diaminopentane or 1,2-diaminopentane), diaminohexane (for example 1,6-diaminohexane, 1,2-diaminohexane or 1,5-diamino-2-methylpentane), diaminoheptane (for example 1,7-diaminoheptane or 1,2-diaminoheptane), diaminooctane (for example 1,8-diaminooctane or 1,2-diaminooctane), diaminononane (for example 1,9-diaminononane or 1,2-diaminononane), diaminodecane (for example 1,10-diaminodecane or 1,2-diaminodecane), diaminoundecane (for example 1,11-diaminoundecane or 1,2-diaminoundecane), diaminododecane (for example 1,12-diaminododecane or 1,2-diaminododecane), wherein the corresponding α,ω-diamines are preferred over their 1,2-isomers, 3,3′-dimethyl-4,4′-diaminodicyclohexylmethane, 4,4′-diaminodicyclohexylmethane, isophoronediamine, 2,2-dimethylpropane-1,3-diamine, 4,7,10-trioxatridecane-1,13-diamine, 4,9-dioxadodecane-1,12-diamine, polyetheramines and 3-(methylamino)propylamine. 1,2-Ethylenediamine and 1,4-butanediamine are preferred. The reaction is controlled in such a way as to obtain, as end group, propyleneamine radicals, butyleneamine radicals, pentyleneamine radicals, hexyleneamine radicals, heptyleneamine radicals, octyleneamine radicals, nonyleneamine radicals and/or decyleneamine radicals, preferably propyleneamine and/or butyleneamine radicals. This may be controlled for example through the se-quence of addition of the starting compounds to the reaction mixture.

Suitable catalysts for polytransamination especially include heterogeneous catalysts comprising one or more transition metals selected from the group of Fe, Co, Ni, Ru, Rh, Pd, Os, Ir, and Pt, preferably from the group of Co, Ni, Ru, Cu and Pd, particularly preferably from the group consisting of Co, Ni and Cu.

The polytransamination is performed in the presence of hydrogen, for example at a partial hydrogen pressure of 1 to 400 bar, preferably at 1 to 200 bar, and most preferably at 1 to 100 bar and at reactor temperatures in a range from 50° C. to 200° C., preferably in a range from 90° C. to 180° C. and most preferably in a range from 130° C. to 170° C.

In a particularly preferred embodiment the polymeric amines (d) according to the invention are obtained by polytransamination of monomer (A), optionally monomer (B) and/or optionally monomer (C), wherein monomer (A) may be described by the formula:

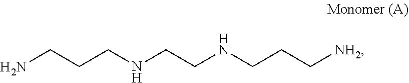 [SMILES: NCCCNCCNCCCN]

monomer (B) may be described by the formula:

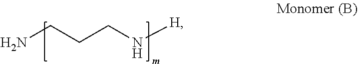

and monomer (C) may be described by the formula:

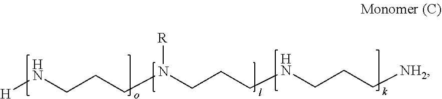

wherein k is between 0 and 1, l is between 1 and 3, m is between 1 and 4, o is between 0 and 1, and R describes an alkyl chain between C1 and C18.

Monomer (A) is N,N′-bis(3-aminopropyl)ethylenediamine (N4-amine) which is obtained either as pure material or as a raw mixture from the addition of approximately two equivalents of acrylonitrile onto 1,3-propanediamine (1,3-PDA) with a subsequent reduction. It is preferable when the employed N4-amine has a purity of >80% by weight, particularly preferably >90% by weight and in particular >97% by weight.

An important property of monomer (A) is the disubstituted secondary diamine with a C2 spacer which avoids cyclization to piperazine units in the form of 6- and 7-membered rings (for example piperazine or homopiperazine) during the typical transamination reaction conditions and thus allows formation of higher molecular weight polymers with a high degree of purity.

Examples of monomer (B) are 1,3-PDA (m=1) and oligomers thereof such as N1-(3-aminopro-pyl)propane-1,3-diamine (m=2), N1,N1′-(propane-1,3-diyl)bis(propane-1,3-diamine) (m=3) and N1-(3-aminopropyl)-N3-(3-((3-aminopropyl)amino)propyl)propane-1,3-diamine (m=4) or a mixture thereof. A particularly suitable monomer (B) is 1,3-PDA.

Examples of monomer (C) are N1-methylpropane-1,3-diamine (o=0, l=1, k=0, R═CH3), N1-(3-aminopropyl)-N1-methylpropane-1,3-diamine (o=1, l=1, k=0, R═CH3), N1-(3-aminopro-pyl)-N3-methylpropane-1,3-diamine (o=0, l=1, k=1, R═CH3), N,N-bis(3-aminopropyl)methylamine (o=1, l=1, k=1, R═CH3) and monomer having a variation of o=0-1, l=1-3 and k=0-1 and mixtures thereof. The R-group of monomer (C) is selected from C1-C18 alkyl radicals, preferably C1-C4 and most preferably methyl. The monomer (C) is particularly suitably N,N-bis(3-aminopropyl)methylamine (BAPMA).

To produce the polymeric amine (d) according to the invention monomer (A), optionally monomer (B) and/or optionally monomer (C) are preferably premixed in the form of a solution and conveyed into the reactor. Alternatively, monomer (A), optionally monomer (B) and/or optionally monomer (C), preferably in the form of solutions, are pumped independently of one another and combined just before the reactor.

The compound (d) is preferably employed in an amount of 0.001% to 5% by weight, particularly preferably 0.01% to 2% by weight, more preferably 0.05% to 1% by weight and in particular 0.1% to 0.5% by weight, in each case based on the weight of the component (b).

When the polyurethane according to the invention is to be in the form of a polyurethane foam reaction mixtures according to the invention further comprise blowing agent (e). Any blowing agents known for the production of polyurethanes may be employed. These may comprise chemical and/or physical blowing agents. Such blowing agents are described for example in “Kunststoffhandbuch”, volume 7, “Polyurethane”, Carl Hanser Verlag, 3rd edition 1993, chapter 3.4.5. “Chemical blowing agents” is to be understood as meaning compounds that form gas-eous products by reaction with isocyanate. Examples of such blowing agents are water or carboxylic acids. “Physical blowing agents” is to be understood as meaning compounds that are dissolved or emulsified in the input materials of polyurethane production and vaporize under the conditions of polyurethane formation. Examples thereof include hydrocarbons, halogenated hydrocarbons and other compounds, for example perfluorinated alkanes, such as perfluorohex-ane, chlorofluorohydrocarbons, and ethers, esters, ketones, acetals and/or liquid carbon diox-ide. The blowing agent may be employed in any desired amount. The blowing agent is preferably employed in an amount such that the resulting polyurethane foam has a density of 10 to 850 g/L, particularly preferably 20 to 800 g/L and in particular 25 to 500 g/L. It is particularly preferable to employ blowing agents comprising water.

Employable chain extenders and crosslinking agents (f) include compounds having at least two isocyanate-reactive groups and a molecular weight of less than 400 g/mol, wherein molecules having two isocyanate-reactive hydrogen atoms are referred to as chain extenders and molecules having more than two isocyanate-reactive hydrogens are referred to as crosslinking agents. However, it is also possible to dispense with the chain extender or crosslinking agent. However, addition of chain extenders, crosslinking agents, or optionally also mixtures thereof, can prove to be advantageous for modifying mechanical properties, for example hardness.

When chain extenders and/or crosslinking agents are to be employed these are typically employed in amounts of 0.5% to 60% by weight, preferably 1% to 40% by weight and particularly preferably 1.5% to 20% by weight in each case based on the total weight of the components (b) to (f).

When chain extenders and/or crosslinking agents (f) are employed the chain extenders and/or crosslinking agents familiar in the production of polyurethanes may be used. These are preferably low molecular weight compounds having isocyanate-reactive functional groups, for example glycerol, trimethylolpropane, glycol and diamines. Further possible low molecular weight chain extenders and/or crosslinking agents are recited, for example, in “Kunststoffhandbuch”, volume 7, “Polyurethane”, Carl Hanser Verlag, 3rd edition 1993, chapters 3.2 and 3.3.2.

Auxiliaries and/or additives (g) may also be employed. All of the auxiliary and additive substances known for producing polyurethanes may be employed here. Examples include surface-active substances, foam stabilizers, cell regulators, release agents, fillers, dyes, pigments, flame retardants, antioxidants, hydrolysis stabilizers, fungistatic and bacteriostatic substances. Such substances are known and are described for example in “Kunststoffhandbuch”, volume 7, “Polyurethane”, Carl Hanser Verlag, 3rd edition 1993, chapters 3.4.4 and 3.4.6 to 3.4.11.

Especially the combination of compounds (d) and antioxidants leads to a further reduced emission of organic substances, such as aldehydes. Examples of antioxidants are phenolic substances, such as 2,6-di-tert-butyl-4-methylphenol, benzenepropanolic acid, 3,5-bis(1,1-di-methylethyl)-4-hydroxy-C7-C9 branched alkyl esters, aminic antioxidants such as N,N′-diisopropyl-p-phenylenediamine, thiosynergists, such as dilauryl 5-thiodipropionate, phosphites and phosphonites, such as triphenylphosphites, diphenylalkylphosphites, benzofuranones and indo-linones, other antioxidants such as O-, N- and S-benzyl compounds, triazine compounds, amides of β-(3,5-di-tert-butyl-4-hydroxyphenyl)propionic acid, esters of substituted and unsubsti-tuted benzoic acids, nickel compounds and esters of β10-thiodipropionic acid or a mixture of two or more of these antioxidants. Such antioxidants are described, for example, in WO2017125291 and are commercially available for example under the trade names Irganox 1076, Irganox 245, Irganox 2000, Irganox E201 (vitamin E), Irganox 5057 or Irgafos 38.

In general the production of the polyurethane according to the invention comprises reacting the polyisocyanates (a), the polyols (b), catalysts (c), compounds (d) and, where employed, the blowing agents (e) and chain extenders (f) and/or crosslinking agents (g) in amounts such that the equivalence ratio of NCO groups of the polyisocyanates (a) to the sum of the reactive hydrogen atoms of the components (b), (c), (d) and optionally (e), (f) and (g) is 0.75 to 1.5:1, preferably 0.80 to 1.25:1. If the cellular plastics at least partially comprise isocyanurate groups, a ratio of NCO groups of the polyisocyanates (a) to the sum of the reactive hydrogen atoms of the components (b), (c), (d) and optionally (e), (f) and (g) of 1.5 to 20:1, preferably 1.5 to 8:1, is typically used. A ratio of 1:1 corresponds to an isocyanate index of 100. In a preferred embodiment an isocyanate component comprising polyisocyanate (a) is reacted with a polyol component comprising polymeric compounds having isocyanate-reactive groups (b), catalyst (c), polymeric amines (d) and blowing agent (e). In a particularly preferred embodiment the polyol component comprises the blowing agent water.

The specific starting substances (a) to (g) for producing polyurethanes according to the invention in each case differ quantitatively and qualitatively only to a small extent when the inventive polyurethane to be produced is a thermoplastic polyurethane, a flexible foam, a semi-rigid foam, a rigid foam or an integral foam. Thus, for example, the production of solid polyurethanes employs no blowing agents and the production of thermoplastic polyurethane employs predomi-nantly strictly difunctional starting substances. It is moreover possible by way of example to vary the elasticity and hardness of the polyurethane of the invention by way of the functionality and the chain length of the higher-molecular-weight compound having at least two reactive hydrogen atoms. Such modifications are known to the person skilled in the art.

The reactants for producing a solid polyurethane are described for example in EP 0989146 or EP 1460094, the reactants for producing a flexible foam for example in PCT/EP2005/010124 and EP 1529792, the reactants for producing a semi-rigid foam for example in “Kunststoffhandbuch, Band 7, Polyurethane”, Carl Hanser Verlag, 3rd edition 1993, chapter 5.4, the reactants for producing a rigid foam for example in PCT/EP2005/010955 and the reactants for producing an integral foam for example in EP 364854, U.S. Pat. No. 5,506,275 or EP 897402. The compounds (d) are then added to the reactants described in these documents in each case.

The invention provides not only the process of the invention but also a polyurethane obtainable by a process of the invention. The polyurethanes according to the invention are preferably used in enclosed spaces, for example as thermal insulation materials in residential buildings, such as insulation for pipes and refrigerators, in furniture construction, for example as decorative elements or as seat cushions, as mattresses and in the interior of vehicles, for example in automobile interiors, for example as steering wheels, dashboards, door trims, carpet foam backings, acoustic foams, such as headliners, and also headrests or gear knobs. For polyurethanes according to the invention especially the formaldehyde emissions are markedly reduced not only compared to a reference product without an additive but also compared to prior art additives for aldehyde reaction. Polyurethanes according to the invention further emit only very small amounts of volatile organic compounds (VOC) according to VDA 278 and VDA 277. Finally, the polyurethanes according to the invention show exceptional aging behavior and heat resistance.

The invention will be illustrated below with reference to examples.

### EXAMPLES

Production of the amine additives A1 to A5 employed the following amines:
N,N′-bis(3-aminopropyl)ethylenediamine (N4-amine)
N,N-bis(3-aminopropyl)methylamine (BAPMA)
1,3-propylenediamine (1,3-PDA)

Amine Additive A1: Synthesis of Polyethylene/-Propylene Copolyamine (Poly(N4-Co-PDA) Copolymer (A1)

Premixed 1,3-PDA with N4-amine in a ratio of 3:1% by weight together with 15 NL/h of hydrogen gas is continuously pumped through a tubular reactor having a filling of a fixed bed catalyst consisting of the metal cobalt, an internal diameter of 10 mm and an internal thermowell of 3.17 mm. The reaction pressure is 50 bar and the reactor temperature 175° C. The premixed starting material was conveyed at a rate of 0.2 kg/LCAT*h. The desired product was obtained directly as a clear output without further processing steps. The obtained product has a weight-average molecular weight of 3250 g/mol.

Amine Additive A2: Synthesis of Polyethylene/-Propylene Copolyamine (Poly(N4-Co-PDA) Copolymer (A2)

Premixed 1,3-PDA with N4-amine in a ratio of 3:1% by weight together with 15 NL/h of hydrogen gas is continuously pumped through a tubular reactor having a filling of a fixed bed catalyst consisting of the metal cobalt, an internal diameter of 10 mm and an internal thermowell of 3.17 mm. The reaction pressure is 50 bar and the reactor temperature 167ºC. The premixed starting material was conveyed at a rate of 0.3 kg/LCAT*h. The output was distilled for 2 hours at 50 mbar and 60° C. and the product obtained as a clear output. The obtained product has a weight-average molecular weight of 702 g/mol.

Amine Additive A3: Synthesis of Polyethylene/-Propylene Copolyamine (Poly N4-Polymer (A3)

N4-amine together with 15 NL/h of hydrogen gas is continuously pumped through a tubular reactor having a filling of a fixed bed catalyst consisting of the metal cobalt, an internal diameter of 10 mm and an internal thermowell of 3.17 mm. The reaction pressure is 50 bar and the reactor temperature 170° C. The premixed starting material was conveyed at a rate of 0.27 kg/LCAT*h. The desired product was obtained directly as a clear output without further processing steps. The obtained product has a weight-average molecular weight of 700 g/mol.

Amine Additive A4: Synthesis of Polypropylene/-2,5-Bis(Aminomethyl)Tetrahydrofuran CopolyamIne (Poly(PDA-Co-2,5-Bis(Aminomethyl)Tetrahydrofuran) Copolymer (A4)

Premixed 1,3-PDA with 2,5-bis(aminomethyl)tetrahydrofuran in a ratio of 3:1% by weight together with 15 NL/h of hydrogen gas is continuously pumped through a tubular reactor having a filling of a fixed bed catalyst consisting of the metal cobalt, an internal diameter of 10 mm and an internal thermowell of 3.17 mm. The reaction pressure is 50 bar and the reactor temperature 170° C. The premixed starting material was conveyed at a rate of 0.28 kg/LCAT*h. The desired product was obtained directly as a clear output without further processing steps. The obtained product has a weight-average molecular weight of 1010 g/mol.

Amine Additive A5: Synthesis of Polyethylene/-Propylene BAPMA Copolyamine (Poly(N4-Co-PDA-Co-BAPMA) Copolymer (A5)

Premixed 1,3-PDA with N4-amine and BAPMA in a ratio of 4:3:3% by weight together with 15 NL/h of hydrogen gas is continuously pumped through a tubular reactor having a filling of a fixed bed catalyst consisting of the metal cobalt, an internal diameter of 10 mm and an internal thermowell of 3.17 mm. The reaction pressure is 50 bar and the reactor temperature 170° C. The premixed starting material was conveyed at a rate of 0.28 kg/LCAT*h. The desired product was obtained directly as a clear output without further processing steps. The obtained product has a weight-average molecular weight of 770 g/mol.

Amine additive V1: Tri-n-propylenetetraamine (TPTA)

Amine additive V2: N,N′-bis(3-aminopropyl)ethylenediamine (N4-amine)

Amine additive V3: Mixture of 50% by weight of tri-n-propylenetetraamine and 50% by weight of N,N′-bis(3-aminopropyl)ethylenediamine

Production of the polyurethane foams employed the following starting materials:

Polyol 1: Glycerol-started polyether polyol based on ethylene oxide and propylene oxide having an average OH number of 27 mg KOH/g, an average functionality of 2.5 and a propylene oxide content based on the total weight of the polyether of 78% by weight.

Polyol 2: Glycerol-started polyether polyol based on ethylene oxide and propylene oxide having an average OH number of 35 mg KOH/g, an average functionality of 2.7 and a propylene oxide content based on the total weight of the polyether of 85% by weight.

Polyol 3: Glycerol-started polyether polyol based on ethylene oxide and propylene oxide having an average OH number of 42 mg KOH/g, an average functionality of 2.7 and a propylene oxide content based on the total weight of the polyether of 25% by weight.

Polyol 4: Polyester polyol formed from adipic acid, 1,4-butanediol, isophthalic acid and mo-noethylene glycol having an average OH number of 55 mg KOH/g.
TEOA Triethanolamine
Isopur® SU-12021 Black paste from ISL-Chemie
Emulsifier: Half-ester of a maleic acid-olefin copolymer
Jeffcat® ZF 10: Amine catalyst from Huntsman

Isocyanate 1: Polymeric diphenylmethane diisocyanate (PMDI) having an NCO content of 31.5% by weight and an average functionality of 2.7.

Isocyanate 2: Prepolymer of methylenediphenyl diisocyanate, dipropylene glycol and polyether polyol having an average OH number of 250 mg KOH/g, a functionality of 2, a propylene oxide content based on the total weight of the polyether of 83% by weight, an NCO content of 23% by weight and an average functionality of 2.

Isocyanate 3: Mixture of methylenediphenyl diisocyanate and the corresponding carbodiimide having an NCO content of 29.5% by weight and an average functionality of 2.2.

The polyol component was produced by mixing the following components:

50.0 parts by weight of polyol 1
34.3 parts by weight of polyol 2
2.0 parts by weight of polyol 3
6.0 parts by weight of polyol 4
0.5 parts by weight of TEOA
0.5 parts by weight of emulsifier
0.5 parts by weight of Isopur ® SU-12021
2.9 parts by weight of water
0.3 parts by weight of Jeffcat ® ZF10
0.1 parts by weight of additive A1-A5 or V1-V3.

The isocyanate component was produced by mixing the following components:

30.0 parts by weight of iso 1
35.0 parts by weight of iso 2
35.0 parts by weight of iso 3

The polyol component and the isocyanate component were intermixed at an isocyanate index of 100 and added to a closed mold to afford moldings having an average density of 120 g/L. The moldings were air-tightly and light-tightly packed directly after production and stored at 25° C. for 3-10 days after production until measurement of the emissions. For the obtained semi-rigid polyurethane foams, hereinbelow referred to as examples 1 to 5 and comparative examples 1 to 3, the emission values were subsequently determined as follows:

Formaldehyde and acetaldehyde was determined by a procedure analogous to ASTM D-5116-06. The chamber size was 4.7 liters. The polyurethane samples used were pieces measuring 110 mm×100 mm×25 mm from the interior of the foam. The temperature in the measuring chamber during measurement was 65° C., the relative humidity 50%. The air change rate was 3.0 liters per hour. The exhaust air stream comprising volatile aldehydes from the polyurethane was passed through a cartridge comprising silica coated with 2,4-dinitrophenylhydrazine (DNPH) over 120 minutes. The DNPH cartridge was then eluted with a mixture of acetonitrile and water. The concentration of formaldehyde and acetaldehyde in the eluate was determined by HPLC UV-Vis. With this setup the limit of detection (NG) for formaldehyde emissions is ≤5 μg/m³ and for acetaldehyde emissions is ≤6 μg/m³.

Table 1: Formaldehyde and acetaldehyde emissions determined in the chamber and VOC and FOG emissions (determined according to VDA 278) from the semi-rigid foams upon addition of the respective additives A1-A5 and V1-V2 in the specified concentrations, in each case reported in % by weight of the abovementioned mixture A.

TABLE 1

| | % by weight | | |
|---|---|---|---|
| | of additive | FA | |
| | in polyol | emission | AA emission |
| | component | (μg/m³) | (μg/m³) |
| Reference | — | 677 | 257 |
| +A1 | 0.1 | <NG | 261 |
| +A2 | 0.1 | <NG | 219 |
| +A3 | 0.1 | <NG | 210 |
| +A4 | 0.1 | <NG | 230 |
| +A5 | 0.1 | <NG | 255 |
| +V1 | 0.1 | 31 | 462 |
| +V2 | 0.1 | <NG | 451 |
| +V3 | 0.1 | 18 | 472 |

Table 1 shows that the use of the inventive additives A1-A5 in mixture A markedly reduces formaldehyde emissions and acetaldehyde emissions remain unchanged or are slightly reduced. Additives V1-V3 likewise result in a reduction in formaldehyde emissions but also in an increase in acetaldehyde emissions.

Table 2: VOC and FOG emissions (determined according to VDA 278) from semi-rigid foams upon addition of the respective additives A5 and V1-V3 in the specified concentrations, in each case reported in % by weight of the abovementioned mixture A.

TABLE 2

| | % by weight of | Voc | |
|---|---|---|---|
| Foam with | additive in polyol | emission | FOG emission |
| additive . . . | component | (μg/m³) | (μg/m³) |
| +A5 | 0.1 | 27/26 | 104 |
| +V1 | 0.1 | 32/36 | 182 |
| +V2 | 0.1 | 37/39 | 296 |
| +V3 | 0.1 | 46/43 | 307 |

Table 2 shows that the use of the inventive additives in mixture A has the result that both VOC and FOG emissions are below the level of the corresponding foams with additives V1-V3.

1. A process for producing polyurethanes comprising mixing
(a) polyisocyanate,
(b) polymeric compounds having isocyanate-reactive groups,
(c) optionally catalysts,
(d) polymeric amines of general formula
H₂N—W-NR[W-NR]ₗ-[Q-NR]ₘ-[S—NR]ₙ-W-NH₂
and optionally
(e) blowing agents,
(f) chain extenders and/or crosslinking agents, and
(g) auxiliaries and/or additives
to form a reaction mixture and reacting the reaction mixture to afford the polyurethane, wherein
each W independently at each occurrence represents a linear or branched-chain hydrocarbon having 3 to 10 carbon atoms,
each Q represents an ethylene radical,
each S independently at each occurrence represents a substituted hydrocarbon,
each R independently at each occurrence represents hydrogen or a hydrocarbon radical having 1 to 10 carbon atoms,
H represents a hydrogen atom and N represents a nitrogen atom,
l represents values from 0 to 100,
m represents values from 0 to 50, and
n represents values from 0 to 100,
wherein the polydispersity of the polymeric amines (d) is at least 1.2.

2. The process according to claim 1, wherein W represents propylene or butylene.

3. The process according to claim 1, wherein the number-average molecular weight of the polymeric amines (d) is from 300 to 5000 g/mol determined by GPC.

4. The process according to claim 1, wherein 50% to 100% of the radicals R represent hydrogen.

5. The process according to claim 1, wherein the polymeric compounds having isocyanate-reactive groups (b) comprise polyetherols.

6. The process according to claim 1, wherein the catalysts (c) comprise incorporable amine catalysts.

7. The process according to claim 6, wherein the incorporable catalysts employed are compounds which, in addition to the isocyanate-reactive group(s), comprise one or more tertiary, aliphatic amino groups.

8. The process according to claim 7, wherein at least one tertiary amino group of the incorporable catalyst bears two radicals independently of one another selected from the group consisting of methyl and ethyl and also a further organic radical.

9. The process according to claim 1, wherein the polyurethane is a polyurethane foam having an average density of 10 to 850 g/L.

10. The process according to claim 1, wherein the polyurethane is a compact polyurethane having an average density of more than 850 g/L.

11. The process according to claim 1, wherein the polyurethane is a mattress or a part of an item of furniture.

12. A polyurethane produced by the process according to claim 1.

13. A method of using the polyurethane according to claim 12, the method comprising using the polyurethane in enclosed spaces.

14. A composition comprising (b) polymeric compounds having isocyanate-reactive groups, (c) catalysts and (d) polymeric amines of general formula H₂N—W-NR-[W-NR]ₗ-[Q-NR]ₘ-[S—NR]ₙ-W-NH₂, wherein each W independently at each occurrence represents a linear or branched-chain hydrocarbon having 3 to 10 carbon atoms, each Q represents an ethylene radical, each S independently at each occurrence represents a substituted hydrocarbon, each R independently at each occurrence represents hydrogen or a hydrocarbon radical having 1 to 10 carbon atoms, H represents a hydrogen atom and N represents a nitrogen atom, l represents values from 0 to 20, m represents values from 0 to 10 and n represents values from 0 to 20 and blowing agents comprising water, wherein the polydispersity of the polymeric amines (d) is at least 1.
